(19) United States
(12) Patent Application Publication
(10) Pub. No.: US 2013/0224651 A1
(43) Pub. Date: Aug. 29, 2013

(54) IMAGE RECORDING METHOD

(71) Applicant: CANON KABUSHIKI KAISHA, (US)

(72) Inventors: Yuichiro Kanasugi, Tokyo (JP); Yoshitaka Torisaka, Yokohama-shi (JP)

(73) Assignee: CANON KABUSHIKI KAISHA, Tokyo (JP)

(21) Appl. No.: 13/773,446

(22) Filed: Feb. 21, 2013

(30) Foreign Application Priority Data
Feb. 24, 2012 (JP) 2012-038857

(51) Int. Cl. G03G 13/10

(52) U.S. Cl. CPC C09D 11/102
USPC 430/117.4

(57) ABSTRACT

An image recording method includes forming an intermediate image on an intermediate transfer body by using an ink and a liquid composition that contains a reactant and a siloxane compound represented by formula (1) and transferring the intermediate image. The intermediate transfer body has a contact angle of 50° or more and 120° or less with respect to water. The siloxane compound is such a siloxane compound that a 1:1 (w/w) mixture of the siloxane compound and water is in a phase separation state or exhibits a turbidity of 200 formazin turbidity units or more and has a functional group equivalent of 500 g/mol or more and 4500 g/mol or less.

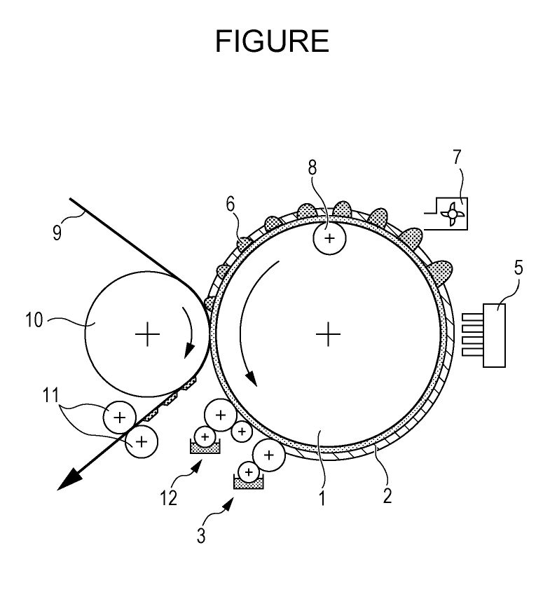

### BACKGROUND OF THE INVENTION

1. Field of the Invention

The present invention relates to an image recording method.

2. Description of the Related Art

An image recording method with which an intermediate image is formed by applying an ink to an intermediate transfer body and transferred onto a recording medium so as to record an image is known (hereinafter this image recording method may be referred to as “intermediate transfer-type image recording method”). It has been a known practice in this intermediate transfer-type image recording method to apply a liquid composition containing a reactant to the surface of the intermediate transfer body prior to forming an intermediate image on the intermediate transfer body so that the colorant in the ink that has landed on the surface can quickly agglomerate or precipitate. This intermediate transfer body to which the liquid composition is applied is typically formed by using a material having a repelling property in order to improve the transfer property.

Typically, a liquid composition applied to the transfer body surface having such a repelling property does not evenly cover the surface since the liquid composition applied is repelled at the surface of the transfer body. If an intermediate image is formed on the liquid composition, which has not been uniformly applied, agglomeration or precipitation reaction may not sufficiently occur in some parts and the intermediate image may be transferred onto a recording medium before the ink becomes sufficiently viscous, causing degradation in image quality such as a phenomenon called “image deletion”.

Accordingly, in order to achieve both high image quality and good transfer property, it is important that the liquid composition be capable of forming a uniform coating on a repelling transfer body so that there are no parts where the liquid composition is repelled. For example, Japanese Patent Laid-Open No. 2009-234219 (referred to as '219 document hereinafter) discloses a liquid composition that contains a particular fluorine-based anionic surfactant so as to enhance the wettability of the liquid composition to the intermediate transfer body and to allow the liquid composition to form a uniform coating, thereby achieving improved image quality.

However, the inventors have conducted studies and found that although high definition intermediate images can be obtained by the intermediate transfer-type image recording method described in '219 document due to a good coatability of the liquid composition, the intermediate image transfer property is not sufficiently good for high-speed printing, leaving some parts of the intermediate image untransferred, resulting in a phenomenon “incomplete transfer” and in degradation of image quality in some cases.

### SUMMARY OF THE INVENTION

It is desirable to provide an image recording method with which a liquid composition can be evenly applied to an intermediate transfer body to form a high quality intermediate image and the intermediate image can be smoothly transferred onto a recording medium in a short transfer pressure application time.

An image recording method include applying a liquid composition to an intermediate transfer body, the liquid composition containing a reactant capable of agglomerating or precipitating a colorant in an ink; forming an intermediate image by applying the ink to the intermediate transfer body to which the liquid composition has been applied; and transferring the intermediate image onto a recording medium. The intermediate transfer body has a surface that has a contact angle of 50° or more and 120° or less with respect to water. The liquid composition contains a siloxane compound represented by formula (1) and the siloxane compound is such a siloxane compound that a 1:1 (w/w) mixture of the siloxane compound and water is in a phase separation state or exhibits a turbidity of 200 formazin turbidity units or more:

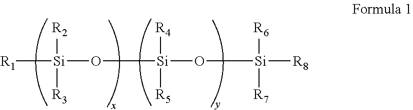

(where, in formula (1), R₂ and R₃ each represent a monovalent alkyl group; R₁ and R₄ to R₈ each represent a monovalent alkyl group or a functional group which is a monovalent organic group containing oxygen or nitrogen; at least one of R₁ and R₄ to R₈ represents the functional group which is a monovalent organic group containing oxygen or nitrogen; x represents an integer of 0 or more; and y represents an integer of 1 or more). The siloxane compound has a functional group equivalent of 500 g/mol or more and 4500 g/mol or less.

According to the image recording method, the transfer body surface exhibits an appropriate repelling property, which makes it possible to smoothly transfer an intermediate image onto a recording medium. At the same time, the transfer body surface exhibits an appropriate wettability and sufficiently holds the intermediate image at a predetermined position.

Further features of the present invention will become apparent from the following description of exemplary embodiments with reference to the attached drawing.

### BRIEF DESCRIPTION OF THE DRAWINGS

FIGURE is a cross-sectional view showing an overall structure of an image recording apparatus used in an embodiment.

### DESCRIPTION OF THE EMBODIMENTS

The inventors have conducted studies and found that a good intermediate image is formed on a transfer body surface and is smoothly transferred to a recording medium when the following requirements are met. That is, an image recording apparatus according to an embodiment satisfies the following four technical requirements.

First, the intermediate transfer body has a surface that has a contact angle of 50° or more and 120° or less with respect to water.

Second, a liquid composition applied to the intermediate transfer body contains a siloxane compound represented by formula (1) below:

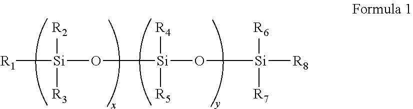

(where, in formula (1), R₂ and R₃ each represent a monovalent alkyl group; R₁ and R₄ to R₈ each represent a monovalent alkyl group or a functional group which is a monovalent organic group containing oxygen or nitrogen; at least one of R₁ and R₄ to R₈ represents the functional group which is a monovalent organic group containing oxygen or nitrogen; x represents an integer of 0 or more; and y represents an integer of 1 or more).

Thirdly, the siloxane compound represented by formula (1) is such a siloxane compound that a 1:1 (w/w) mixture of the siloxane compound and water is in a phase separation state or exhibits a turbidity of 200 formazin turbidity units (FTU) or more.

Fourthly, the functional group equivalent of the siloxane compound represented by formula (1) is 500 g/mol or more and 4500 g/mol or less.

When these requirements are satisfied, the transfer body surface to which the liquid composition is applied exhibits an appropriate repelling property and an appropriate wettability, a high-definition intermediate image is formed on the transfer body surface, and the intermediate image can be smoothly transferred onto a recording medium.

FIGURE is a cross-sectional view showing an overall structure of an image recording apparatus according to an embodiment. A core 1 is constituted by a rotating body and coated with an intermediate transfer body 2. Units used to perform a basic process, namely, a liquid applying member 3 that applies a liquid composition, an inkjet head 5 that forms an intermediate image 6, and a transfer roller 10 for transferring the intermediate image 6 onto a recording medium 9 are disposed around the intermediate transfer body 2. A solvent removing unit 7 and a heating unit 8 are disposed between the inkjet head 5 and the transfer roller 10 to quickly decrease the amount of the solvent in the applied ink. A cleaning unit 12 is disposed between the transfer roller 10 and the liquid applying member 3 to remove the ink remaining on the intermediate transfer body 2 after the transfer. A fixing roller 11 is provided to fix the image transferred onto the recording medium 9 in a short time.

The core 1 is rotated in the arrow direction in the drawing and a liquid composition is applied to the intermediate transfer body 2 from the liquid applying member 3. Then the inkjet head 5 having nozzle rows corresponding to different colors ejects inks in response to image data to form the intermediate image 6. The intermediate image 6 is processed with the solvent removing unit 7 and the heating unit 8 before transferring so that the ink viscosity is suitable for the transfer. Then the intermediate image 6 is transferred onto a recording surface of the recording medium 9 by using the transfer roller 10. After the transfer, the surface of the intermediate transfer body 2 is cleaned with the cleaning unit 12. This constitutes one cycle. As the core 1 is continuously rotated, final images are repeatedly formed on the recording medium 9.

The core 1 may have a shape of a roller or a belt. A rotating body having a drum shape and being composed of a light-weight metal such as an aluminum alloy is used as the core 1 so that the core 1 has dimensional accuracy and stiffness withstanding the pressure applied during the transfer and that the rotational inertia can be reduced.

The core 1 may be composed of a material that has a particular strength from the viewpoints of transfer accuracy and durability. Metals, ceramics, and polymers are suitable as such a material. Examples of the material that has dimensional accuracy and stiffness for withstanding the pressure applied during the transfer, reduces the inertia during operation, and improves the responsiveness to control include aluminum, iron, stainless steel, acetal polymers, epoxy polymers, polyimide, polyethylene, polyethylene terephthalate, nylon, polyurethane, silica ceramics, and alumina ceramics. These may be used in combination.

The first technical requirement of the present invention is that the surface of the intermediate transfer body 2 coating the core 1 has a contact angle of 50° or more and 120° or less with respect to water. The “contact angle” means a static contact angle measured with a contact angle meter (CA-V produced by Kyowa Interface Science Co., Ltd.).

A transfer body surface having a contact angle of 50° with respect to water exhibits an appropriate repelling property. Since the wettability will be excessively degraded at an excessively large contact angle to water, the contact angle is to be 120° or less in order to impart an appropriate degree of wettability to the transfer body surface during formation of the intermediate image and form a high-definition intermediate image. The repelling property is a property of the surface that makes materials, such as inks, reactants, and clear inks, less sticky to the surface and detachable from the surface in the later step. The contact angle is preferably 60° or more and more preferably 110° or more.

The intermediate transfer body 2 that coats the core 1 may have a particular degree of elasticity in order to transfer an image onto a recording medium such as paper by pressure-bonding. For example, when paper is used as a recording medium, the hardness of the intermediate transfer body 2 is preferably 10° or more and more preferably 20° or more but preferably 100° or less and more preferably 60° or less in terms of hardness determined with a type A durometer (in accordance with Japanese Industrial Standards (JIS) K6253).

Examples of the material that constitutes the intermediate transfer body 2 include polymers, ceramics, and metals. In view of the properties and processing properties described above, various types of rubber materials and elastomer materials may be used. Examples thereof include polybutadiene rubber, nitrile rubber, chloroprene rubber, silicone rubber, fluorine rubber, fluorosilicone rubber, urethane rubber, styrene elastomers, olefin elastomers, vinyl chloride elastomers, ester elastomers, and amide elastomers. Polyethers, polyesters, polystyrenes, polycarbonates, siloxane compounds, and perfluorocarbon compounds may also be used.

The intermediate transfer body 2 may be constituted by plural layers of different materials. For example, the intermediate transfer body 2 may be an endless belt composed of urethane rubber coated with silicone rubber, a sheet composed of polyethylene terephthalate (PET) coated with silicone rubber, or a urethane rubber or silicone rubber sheet on which a siloxane compound layer is formed. Examples of the siloxane compound include those constituted by condensates from hydrolyzable organic silicon compounds. Also used is a sheet obtained by impregnating a base cloth, such as a cotton cloth or a woven cloth of polyester, rayon, or the like, with a rubber material such as nitrile butadiene rubber or urethane rubber.

The intermediate transfer body 2 may be subjected to an appropriate surface treatment and used. Examples of the treatment include a flame treatment, a corona treatment, a plasma treatment, a polishing treatment, a roughening treatment, an active energy ray (UV, IR, RF, or the like) irradiation treatment, ozone treatment, a surfactant treatment, and a silane coupling treatment. Two or more of these treatments may be employed in combination.

A particular surface roughness may be imparted to the surface of the intermediate transfer body 2 in order to suppress flowability of the intermediate image formed on the surface. The average surface roughness Ra may be any, for example, about 0.01 to 3 μm.

In this description, the surface of the intermediate transfer body 2 on which an intermediate image is formed is referred to as the “transfer body surface”.

The process from forming an intermediate image on a transfer body surface of the intermediate transfer body 2 to transferring the intermediate image onto a recording medium can be roughly divided into four major steps (a) to (d). Each step is described below.

### (a) Step of Applying Liquid Composition

In step (a), a liquid composition containing a reactant is applied to a transfer body surface of the intermediate transfer body 2 by using a liquid applying member 3. A roll coater is used as the liquid applying member 3 but the liquid applying member 3 is not limited to this. For example, a spray coater, a slit coater, or the like may be used. The reactant is a material that causes the colorant in the ink landed on the transfer body surface to quickly agglomerate or precipitate. In particular, when a dye is used as a colorant, the dye dissolving in the ink precipitates due to the action of the reactant. When a pigment is used as a colorant, the pigment dispersed in the ink agglomerates due to the action of the reactant. The reactant helps increase the viscosity of the ink and retain the intermediate image on the intermediate transfer body. Examples of the reactant include polyvalent metal ions and organic acids.

Examples of the polyvalent metal ions include divalent metal ions such as Ca²⁺, Cu²⁺, Ni²⁺, Mg²⁺, and Zn²⁺ and trivalent metal ions such as Fe³⁺ and Al³⁺. These ions may be applied by being formed into an aqueous metal salt solution. Examples of the anions of the metal salts include Cl⁻, NO₃⁻, SO₄²⁻, I⁻, Br⁻, ClO₃⁻, and RCOO⁻ (R represents an alkyl group having 1 to 20 carbon atoms). The polyvalent metal ion content may be 5.0 mass % or more and 70.0 mass % or less relative to the total amount of the liquid composition.

An organic acid induces the reaction of precipitating or agglomerating the colorant since the organic acid has an ability to buffer the hydrogen ion concentration (pH). An organic acid may be used as a reactant since the speed of reaction with the colorant in the ink is high. Examples of the organic acid include organic carboxylic acids and organic sulfonic acids. Specific examples thereof include polyacrylic acid, acetic acid, methane sulfonic acid, glycol acid, malonic acid, malic acid, maleic acid, ascorbic acid, succinic acid, glutaric acid, fumaric acid, citric acid, tartaric acid, lactic acid, sulfonic acid, levulinic acid, orthophosphoric acid, pyrrolidonecarboxylic acid, pyronecarboxylic acid, pyrrolecarboxylic acid, furancarboxylic acid, pyridinecarboxylic acid, coumarinic acid, thiophenecarboxylic acid, nicotinic acid, derivatives of these compounds, and salts of these compounds. These compounds may be used alone or in combination. The organic acid content may be 5.0 mass % or more and 90.0 mass % or less relative to the total amount of the liquid composition.

When an organic acid is used as a reactant, the pH of the liquid composition is preferably 4.0 or less, more preferably 1.0 or more and 3.5 or less, and most preferably 1.0 or more and 3.0 or less.

The second technical requirement of this embodiment is that the liquid composition contains a siloxane compound represented by formula (1):

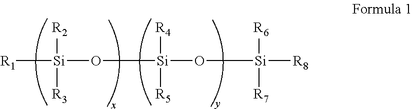

(where, in formula (1), R₂ and R₃ each represent a monovalent alkyl group; R₁ and R₄ to R₈ each represent a monovalent alkyl group or a functional group which is a monovalent organic group containing oxygen or nitrogen; at least one of R₁ and R₄ to R₈ represents the functional group which is a monovalent organic group containing oxygen or nitrogen; x represents an integer of 0 or more; and y represents an integer of 1 or more).

The monovalent alkyl group is expressed as CₙH₂ₙ₊₁. Examples of the alkyl group include a methyl group, an ethyl group, a propyl group, a butyl group, an isopropyl group, and an isobutyl group. The number n of carbon atoms is preferably 100 or less and more preferably 10 or less.

Specific examples thereof include X-22-161B (produced by Shin-Etsu Chemical Co., Ltd.), X-22-3701E (produced by Shin-Etsu Chemical Co., Ltd.), KF-6003 (produced by Shin-Etsu Chemical Co., Ltd.), X-21-5841 (produced by Shin-Etsu Chemical Co., Ltd.), and X-22-4515 (produced by Shin-Etsu Chemical Co., Ltd.).

The third technical requirement of this embodiment is that the siloxane compound represented by formula (1) is such a siloxane compound that a 1:1 (w/w) mixture of the siloxane compound and water is in a phase separation state or exhibits a turbidity of 200 formazin turbidity units (FTU) or more.

Regarding the third technical requirement, a) phase separation and b) turbidity are described below.

### a) Phase Separation

Phase separation here means that the interface between the phases in a liquid mixture of water and the siloxane compound (liquid) represented by formula (1) is recognizable with naked eye.

### b) Turbidity

Turbidity refers to a degree of turbidness of the liquid mixture (water and liquid siloxane compound). The turbidity as used in Examples and Comparative Examples below refers to a value determined by Testing methods for industrial water (JIS K0101).

When the mixture containing the siloxane compound is in a phase separation state or exhibits a turbidity of 200 formazin turbidity units (FTU) or more, the liquid composition can be applied to the transfer body surface evenly and the image quality of the intermediate image formed on the transfer body surface to which the liquid composition is applied is improved.

The fourth technical requirement of this embodiment is that the functional group equivalent of the siloxane compound represented by formula (1) contained in the liquid composition is 500 g/mol or more and 4500 g/mol or less.

The functional group equivalent referred to in here means the mass of the siloxane compound per molar equivalent of a functional group, where the functional group is a monovalent organic group containing oxygen or nitrogen and is represented by at least one of R₁ and R₄ to R₈. The unit of the functional group equivalent is g/mol.

A specific method for calculating the functional group equivalent will now be described by using an example. Suppose that a siloxane compound with R₁ to R₇ each representing a methyl group, R₈ representing an aminopropyl group (C₃H₆NH₂), x=2, and y=3 is used. The molecular weight of this siloxane compound is 501 g/mol and one functional group (amino group) is present per molecule of the siloxane compound. In this case, since the functional group and the siloxane compound are in a 1:1 equivalent relationship, the mass of the siloxane compound corresponding to 1 mol of the functional group is 501 g. The functional group equivalent of this siloxane compound is then calculated to be (501 g)/(1 mol)=501 (g/mol). When a siloxane compound has two functional groups per molecule, the functional group and the siloxane compound are in a 2:1 equivalent relationship. When the molecular weight of the siloxane compound is M (g/mol) and M (g) of the siloxane compound is present, 2 mol equivalent of the functional groups are present and thus the functional group equivalent is calculated to be (M (g))/(2 mol)=M/2 (g/mol).

The inventors have conducted extensive studies and found that the wettability and the transfer property of the transfer body surface to which the liquid composition is applied have the following features when the functional group equivalent of the siloxane compound contained in the liquid composition is used as a parameter.

The liquid composition does not retain sufficient wettability to the transfer body surface when the functional group equivalent of the siloxane compound is less than 500 g/mol. If the functional group equivalent of the siloxane compound exceeds 4500 g/mol, the compatibility with the reactant and the like in the liquid composition is degraded and the liquid composition may not be evenly applied to the transfer body. It is difficult to obtain a high quality intermediate image on the liquid composition not evenly applied.

The functional group here specifically refers to an amino group, a carboxyl group, a carbinol group, a silanol group, ethylene oxide, propylene oxide, or the like. A group containing an amino group has high compatibility in the liquid composition and is thus preferred.

The siloxane compound content in the liquid composition is preferably 10.0 mass % or more, more preferably 15.0 mass % or more, and most preferably 20.0 mass % or more. The siloxane compound content is preferably 90.0 mass % or less, more preferably 80.0 mass % or less, and most preferably 75.0 mass % or less. When the siloxane compound content in the liquid composition is less than 10.0 mass %, the wettability to the intermediate transfer body may not be sufficiently exhibited. At a siloxane content exceeding 90.0 mass %, the reactant content becomes excessively small and agglomeration or precipitation of the colorant may not sufficiently occur, and the image quality and transfer property of the intermediate image may become degraded.

The liquid composition of this embodiment may contain an appropriate amount of water or organic solvent. Water used in this case may be deionized by ion exchange or the like. Any common organic solvent can be used in the liquid composition of this embodiment.

Various polymers may be added to the liquid composition. Addition of an appropriate polymer will facilitate transfer of the intermediate image onto a recording medium during the transfer and improve the scratch resistance of the final image.

A viscosity adjustor may be added to the liquid composition to appropriately control the viscosity. The viscosity adjustor may be any viscosity adjustor that can be used in combination with the siloxane compound and the reactant.

If needed, various types of additives, such as an antirust agent, a preservative, a fungicide, an antioxidant, a reducing inhibitor, and a surfactant, may be added to the liquid composition.

Examples of the method for applying the liquid composition to the transfer body surface include die coating, blade coating, gravure coating, a roller coating method that uses an offset roller, a spraying method such as spray coating, and an ejection method that uses an inkjet device. Two or more of these methods may be employed in combination.

The application amount of the liquid composition applied may be 0.1 g/m² or more and 5.0 g/m² or less. At an application amount less than 0.1 g/m², agglomeration or precipitation of the colorant may not sufficiently occur due to shortage of the reactant. At an application amount exceeding 5.0 g/m², the ink on the liquid composition may remain afloat and unfixed, thereby possibly degrading the image quality.

A liquid composition drying step of removing the water, solvent, and the like contained in the liquid composition that has been applied to the intermediate transfer body by drying so as to form a thin film of the liquid composition may be provided prior to a step of forming an intermediate image.

The ink is then applied to the transfer body surface to which the liquid composition has been applied so as to form an image with the ink. For the sake of convenience, an image formed on the intermediate transfer body 2 before being transferred to a final recording medium is referred to as “intermediate image”.

### b) Step of Forming Intermediate Image

Inks corresponding to desired colors are ejected toward the transfer body surface to which the liquid composition has been applied. The inks are ejected from the inkjet head 5 in accordance with image data.

The type of the inkjet device used in this embodiment may be a type in which an ink is ejected by film-boiling the ink with an electrothermal converter and generating bubbles, a type in which an ink is ejected by using an electromechanical converter, and a type in which the ink is ejected electrostatically. Various types of inkjet devices proposed in the inkjet liquid ejection techniques can be employed. Among these, a technique that uses an electrothermal converter is preferably used to maintain a high-definition recording quality at high speed.

### Composition of Ink

Examples of the colorant used in the ink of this embodiment include solutions and dispersions of known dyes and known pigments such as carbon black. Pigments are particularly preferable as the colorant since the durability of the image is enhanced. The components used as the colorant of the ink are separately described below.

### Pigment

The pigment that can be used in this embodiment may be any common inorganic pigment or organic pigment. Examples thereof include pigments that are referred to by color index (C.I.) numbers. Carbon black may be used as a black pigment. The pigment content in the ink is preferably 0.5 mass % or more and more preferably 1.0 mass % or more but preferably 10.0 mass % or less and more preferably 15.0 mass % or less relative to the total mass of the ink.

### Pigment Dispersant

The pigment dispersant for dispersing the pigment may be any common pigment dispersant but may be a water-soluble pigment dispersant that has a hydrophilic moiety and a hydrophobic moiety. A pigment dispersant composed of a copolymer polymer constituted by a hydrophilic monomer and a hydrophobic monomer is particularly preferable.

The monomers used here may be any. Examples of the hydrophobic monomers include styrene, styrene derivatives, alkyl(meth)acrylates, and benzyl(meth)acrylates. Examples of the hydrophilic monomers include acrylic acid, methacrylic acid, and maleic acid.

The acid value of the pigment dispersant may be 50 mgKOH/g or more and 550 mgKOH/g or less. The weight-average molecular weight of the dispersant may be 1000 or more and 50000 or less.

The ratio of the pigment content to the dispersant content is preferably within the range of 1:0.1 or more and 1:3 or less.

A self dispersion pigment obtained by surface-modifying pigment particles to make the particles self-dispersible without using a pigment dispersant may be used.

### Polymer Particles

The ink used in this embodiment may contain various particles that contain no colorant. Polymer particles are particularly effective in improving the image quality and fixing property and are thus preferred.

The material for the polymer particles used in this embodiment may be any suitable common polymer. Examples thereof include homopolymers such as polyolefins, polystyrenes, polyurethanes, polyesters, polyethers, polyureas, polyamides, polyvinyl alcohols, poly(meth)acrylic acid and salts thereof, polyalkyl(meth)acrylates, and polydienes, and copolymers of these.

The weight-average molecular weight of this polymer may be 1,000 or more and 2,000,000 or less.

The polymer particle content in the ink relative to the total mass of the ink is preferably 1.0 mass % or more and more preferably 2.0 mass % or more but preferably 50 mass % or less and more preferably 40 mass % or less.

In this embodiment, the polymer particles may be prepared into a polymer particle dispersion in which the polymer particles are dispersed in the ink. The technique for dispersing the polymer particles is not particularly limited. A self-dispersion polymer particle dispersion in which a polymer formed by homopolymerization of a monomer having a dissociable group or copolymerization of two or more types of the monomers is dispersed may be used. Examples of the dissociable group include a carboxyl group, a sulfonic acid group, and a phosphoric acid group. Examples of the monomer that has a dissociable group include acrylic acid and methacrylic acid. Alternatively, an emulsion dispersion type polymer particle dispersion in which polymer particles are dispersed by using an emulsifier may be used. The emulsifier may be any common surfactant having a low molecular weight or a high molecular weight. The surfactant may be nonionic or one that has the same electric charge as the polymer particles.

The dispersed particle size of the polymer particle dispersion of this embodiment is preferably 10 nm or more and more preferably 30 nm or more but preferably 1000 nm or less and more preferably 500 nm or less.

In preparing the polymer particle dispersion of this embodiment, various additives may be added to stabilize the polymer particle dispersion. Examples of the additive include n-hexadecane, dodecyl methacrylate, stearyl methacrylate, chlorobenzene, dodecyl mercaptan, olive oil, blue dye (Blue 70), and polymethyl methacrylate.

### Surfactant

The ink that can be used in this embodiment may contain a surfactant. Examples of the surfactant include Acetylenol EH (produced by Kawaken Fine Chemicals Co., Ltd.) and BYK 347, BYK 348, and BYK 349 (produced by BYK Japan KK) composed of polyether siloxane compounds, and Zonyl FSO100 (produced by DuPont) composed of a fluorine compound.

A surfactant composed of a polyether siloxane compound represented by formula (2) has high compatibility with the liquid composition used in this embodiment and is capable of forming good dot shapes:

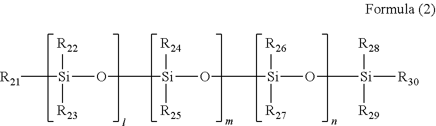

(where, in formula (2), R₂₁ to R₃₀ each represent a monovalent organic group, at least one of R₂₁ to R₃₀ represents a monovalent organic group that contains a structure represented by formula (3), and l, m, and n each represent an integer of 0 or more.)

C₂H₄OₐC₃H₆O_{b} Formula (3)

(where, in formula (3), a and b each represent an integer of 0 or more and the sum of a and b is an integer of 1 or more.)

In this side chain type polyether siloxane compound, (C₂H₄O) represents an ethylene oxide unit and (C₃H₆O) represents a propylene oxide unit. The ethylene oxide units and propylene oxides units may be repeated at random or may be found in blocks and form a block polymer.

The surfactant content may be 0.01 mass % or more and 20.0 mass % or less relative to the total mass of the ink.

### Solvent

The solvent that is used in the ink of this embodiment may be water and/or a water-soluble organic solvent. Water may be deionized by ion exchange or the like.

The water content in the ink may be 30 mass % or more and 97 mass % or less relative to the total mass of the ink.

The water-soluble organic solvent may be any common organic solvent. Examples thereof include glycerin, diethylene glycol, polyethylene glycol, and 2-pyrrolidone.

The water-soluble organic solvent content in the ink may be 3.0 mass % or more and 70 mass % or less relative to the total mass of the ink.

### Other Additives

The ink that can be used in this embodiment may contain various additives in addition to the components described above. Examples of the additives include a pH adjustor, an antirust agent, a preservative, a fungicide, an antioxidant, a reducing inhibitor, a water-soluble polymer and a neutralizing agent thereof, and a viscosity adjustor.

The ink is ejected toward the transfer body surface while taking into account that image transfer is carried out in a reversed manner. In other words, a mirror image of the image that should be formed on the recording medium is formed on the intermediate transfer body.

### (c) Step of Removing Solvent

In this embodiment, a step of removing an adequate amount of the solvent from the intermediate image 6 formed on the surface of the intermediate transfer body 2 may be provided. The intermediate image 6 formed on the surface of the intermediate transfer body 2 as a result of ejection of inks from the inkjet head 5 is treated in the solvent removing unit 7 and the heating unit 8 to accelerate removal of the solvent. This step allows an adequate amount of the solvent to be removed in a short time from the intermediate image. Thus, the viscosity of the intermediate image is appropriately increased and the transfer property is improved. However, this step of removing the solvent is optional.

The solvent may be removed by any common technique employed in the intermediate transfer type image recording methods. A method with which the solvent is evaporated by heating, a method with which the solvent is evaporated by blowing air having low humidity, a method with which the solvent is evaporated by depressurizing, a method with which the solvent is blown away by sending air, or any combination of these methods may be employed.

### (d) Transfer Step

The intermediate image 6 having an increased viscosity as a result of removal of an adequate amount of solvent is transferred onto the recording medium 9 by using the transfer roller 10. At this stage, the ink constituting the intermediate image has an adequately high viscosity on the surface of the intermediate transfer body 2 and thus an appropriate image can be formed on a recording medium that absorbs little or no ink, such as printing paper or a film.

The transfer pressure application time taken to press the intermediate image between the recording medium 9 and the surface of the intermediate transfer body 2 may be 1 msec or more and 100,000 msec or less. If the transfer pressure application time is shorter than 1 msec, the intermediate image 6 may remain on the surface of the intermediate transfer body 2, resulting in transfer failure. If the transfer pressure application time is longer than 100,000 msec, the transfer speed may be decreased and the productivity of the final images may be degraded, or the increase in nip distance may result in increase in size of the apparatus.

Next, Exemplary Examples and Comparative Examples are described. In the description below, “parts” and “%” are on a mass basis unless otherwise noted.

### EXAMPLES

### Example 1

In this example, an aluminum drum serving as a core 1 constituting a rotating body was coated with silicone rubber so as to form an intermediate transfer body A that coats the core 1. The intermediate transfer body A used in Example 1 constituted a siloxane compound surface layer having a water contact angle of 100°, which is in a range of 50° or more and 120° or less.

### (a) Step of Applying Liquid Composition

### Liquid Composition 1

A liquid composition 1 used in this embodiment contained 50 mass % of levulinic acid and 50 mass % of a siloxane compound 1 (X-22-161B produced by Shin-Etsu Chemical Co., Ltd.) having a structure represented by formula (1) as shown in Table 2.

A 1:1 (w/w) liquid mixture containing the siloxane compound 1 and water exhibits a turbidity of 200 FTU or more as shown in Table 3.

The siloxane compound 1 contains an amino group as an organic group that contains oxygen or nitrogen and has a functional group equivalent of 1500 g/mol, which is in the range of 500 g/mol or more and 4500 g/mol or less, as shown in Table 3.

In Example 1, a roll coater 3 is provided as a device for applying the liquid composition 1 to the transfer body surface. The liquid composition 1 was applied to the transfer body surface by using the roll coater 3. In Example 1, 0.5 g/m² of the liquid composition 1 was applied to the surface of the intermediate transfer body A.

### (b) Step of Forming Intermediate Image

Next, ink was ejected from an inkjet head 5 to form an intermediate image 6 (mirror image) on the intermediate transfer body. A drop-on-demand-type line head inkjet head that ejects ink by using electrothermal conversion elements was used in this embodiment.

Ink 1 used in Example 1 was obtained by separately preparing individual components of the ink as follows.

### Preparation of Black Pigment Dispersion Liquid

| | |
|---|---|
| Carbon black (trade name: MONARCH 1100, produced by | 10 parts |
| Cabot Corporation) | |
| Styrene-ethyl acrylate-acrylic acid copolymer (acid value: | 15 parts |
| 150, weight-average molecular weight: 8000, solid content: | |
| 20%, neutralized with potassium hydroxide) | |
| Ion exchange water | 75 parts |

A mixture of the above-described components was fed to a batch-type vertical sand mill (produced by AIMEX CO. Ltd.), 200 parts of zirconia beads 0.3 mm in diameter were filled therein, and the resulting mixture was dispersed for 5 hours under water cooling. The resulting dispersion liquid was centrifuged to remove coarse particles. As a result, a black pigment dispersion liquid having a pigment concentration of about 10 mass % was obtained.

### Preparation of Polymer Particle Dispersion

Ethyl methacrylate (18 parts), 2,2′-azobis-(2-methylbutyronitrile) (2 parts), and n-hexadecane (2 parts) were mixed and stirred for 0.5 hours. The resulting mixture was added to 78 parts of a 6 mass % aqueous solution of NIKKOL BC20 (emulsifier produced by Nikko Chemicals Co., Ltd.) dropwise, followed by stirring for 0.5 hours. Then the resulting liquid mixture was irradiated with ultrasonic waves for 3 hours by using an ultrasonic irradiator. Then the polymerization reaction was carried out in a nitrogen atmosphere at 85° C. for 3 hours and the resulting reaction product was cooled to room temperature and filtered to obtain a polymer particle dispersion having a polymer content of about 20 mass %. The weight-average molecular weight of the polymer particles was about 1,100,000 and the dispersed particle size was about 140 nm.

### Preparation of Ink 1

An ink 1 having a composition shown in Table 4 was prepared by using the black pigment dispersion liquid and the polymer particle dispersion described above.

| | |
|---|---|
| Black pigment dispersion liquid | 20 parts |
| Polymer particle dispersion | 50 parts |
| Diethylene glycol | 10 parts |
| Ion exchange water | 14 parts |
| BYK 349 | 6 parts |

These components were mixed, thoroughly stirred, and pressure-filtered through a microfilter (produced by FUJIFILM Holdings Corporation) with a 3.0 μm pore size to prepare an ink 1 (black ink).

### (c) Step of Removing Liquid

In Example 1, the intermediate image formed was heated and dried with a solvent removing unit 7 and a heating unit 8 so as to adjust the ink viscosity of the intermediate image to an appropriate level, and then transferred to a recording medium. An air blower was used as the solvent removing unit 7. Hot air at 50° C. was applied to the intermediate image for 15 seconds to evaporate an appropriate amount of the solvent contained in the intermediate image.

### (d) Transfer Step

A transfer roller 10 was provided to bring a recording medium 9 to make contact with the intermediate image 6 on the intermediate transfer body and transfer the intermediate image 6 onto the recording medium 9. The intermediate image 6 was transferred by applying a pressure between the transfer roller 10 and the recording medium 9. The transfer pressure application time was 8 msec (transfer speed: 1 m/sec, roller nip length: 8 mm) and printing paper (trade name: Tokubishi Art Double Sided N, 127.9 g/m², produced by Mitsubishi Paper Mills Limited) was used as a recording medium.

In this example, a long rolled sheet was used as the recording medium. Alternatively, the recording medium may be a cut sheet cut into a predetermined size.

In Example 1, the intermediate transfer body after the intermediate image was transferred to the recording medium was used repeatedly to form a next image and thus a cleaning unit 12 was provided.

### Example 2

Example 2 was the same as Example 1 except that the liquid composition 1 used in Example 1 was changed to a liquid composition 2 shown in Table 2.

### Example 3

Example 3 was the same as Example 1 except that the liquid composition 1 used in Example 1 was changed to a liquid composition 3 shown in Table 2.

### Example 4

Example 4 was the same as Example 1 except that the liquid composition 1 used in Example 1 was changed to a liquid composition 4 shown in Table 2.

### Example 5

Example 5 was the same as Example 1 except that the liquid composition 1 used in Example 1 was changed to a liquid composition 5 shown in Table 2.

### Example 6

Example 6 was the same as Example 1 except that the intermediate transfer body A used in Example 1 was changed to an intermediate transfer body B shown in Table 1. The intermediate transfer body B was obtained as follows. First, glycidoxypropyltriethoxysilane and methyltriethoxysilane were mixed with each other at a molar ratio of 1:1 and refluxed under heating for 24 hours or longer in a water medium in the presence of hydrochloric acid as a catalyst so as to obtain a hydrolyzable condensate solution. The hydrolyzable condensate solution was diluted with methyl isobutyl ketone to 15 mass % and 5 mass % of a photocationic polymerization initiator SP150 (produced by ADEKA CORPORATION) was added thereto to obtain a coating liquid. The coating liquid was applied to silicone rubber on an aluminum drum constituting the core so as to form a film of the coating liquid thereon. The silicone rubber had been preliminarily subjected to a plasma treatment to improve the coatability. The surface was irradiated with a UV lamp to conduct exposure and the film was cured by heating at 135° C. for 2.5 hours. As a result, an intermediate transfer body B was obtained.

### Example 7

Example 7 was the same as Example 1 except that the ink 1 used in the Example 1 was changed to an ink 2 shown in Table 4.

### Comparative Example 1

Comparative Example 1 was the same as Example 1 except that the liquid composition 1 used in Example 1 was changed to a comparative liquid composition 1 shown in Table 2.

### Comparative Example 2

Comparative Example 2 was the same as Example 1 except that the liquid composition 1 used in Example 1 was changed to a comparative liquid composition 2 shown in Table 2.

### Comparative Example 3

Comparative Example 3 was the same as Example 1 except that the liquid composition 1 used in Example 1 was changed to a comparative liquid composition 3 shown in Table 2.

### Comparative Example 4

Comparative Example 4 was the same as Example 1 except that the liquid composition 1 used in Example 1 was changed to a comparative liquid composition 4 shown in Table 2.

### Comparative Example 5

Comparative Example 5 was the same as Example 1 except that the intermediate transfer body A used in Example 1 was changed to a comparative intermediate transfer body C shown in Table 1.

TABLE 1

| Intermediate | | Contact angle |
|---|---|---|
| transfer body | Material | to water |
| Intermediate | Silicone rubber (siloxane compound) | 100° |
| transfer body A | Trade name: KE12 (produced by Shin- | |
| | Etsu Chemical Co., Ltd.) | |
| Intermediate | Silicone rubber coated with a siloxane | 55° |
| transfer body B | compound surface layer | |
| Comparative | Urethane rubber | 30° |
| intermediate | Trade name: Ti-Prene (produced by | |
| transfer body C | Tigers Polymer Corporation) | |

TABLE 2

| | | | Siloxane | | | | Organic | | |
|---|---|---|---|---|---|---|---|---|---|
| | Reactant | | compound | | Surfactant | | solvent | | Water |
| | Type | Mass % | Type | Mass % | Type | Mass % | Type | Mass % | Mass % |
| Liquid | Levulinic | 50 | Siloxane | 50 | — | — | — | — | — |
| composition 1 | acid | | compound 1 | | | | | | |
| Liquid | Levulinic | 50 | Siloxane | 50 | — | — | — | — | — |
| composition 2 | acid | | compound 2 | | | | | | |
| Liquid | Levulinic | 50 | Siloxane | 50 | — | — | — | — | — |
| composition 3 | acid | | compound 3 | | | | | | |
| Liquid | Levulinic | 50 | Siloxane | 50 | — | — | — | — | — |
| composition 4 | acid | | compound 4 | | | | | | |
| Liquid | Levulinic | 50 | Siloxane | 50 | — | — | — | — | — |
| composition 5 | acid | | compound 5 | | | | | | |
| Comparative | Levulinic | 50 | Comparative | 50 | — | — | — | — | — |
| liquid | acid | | siloxane | | | | | | |
| composition 1 | | | compound 1 | | | | | | |
| Comparative | Levulinic | 50 | Comparative | 50 | — | — | — | — | — |
| liquid | acid | | siloxane | | | | | | |
| composition 2 | | | compound 2 | | | | | | |
| Comparative | Levulinic | 50 | Comparative | 50 | — | — | — | — | — |
| liquid | acid | | siloxane | | | | | | |
| composition 3 | | | compound 3 | | | | | | |
| Comparative | Levulinic | 50 | — | — | Fluorine-based | 1 | Glycerin | 5 | 44 |
| liquid | acid | | | | anionic surfactant | | | | |
| composition 4 | | | | | MEGAFACE F- | | | | |
| | | | | | 114 (produced by | | | | |
| | | | | | DIC Corporation) | | | | |

In Table 3, “Turbidity of 1:1 water/siloxane compound liquid mixture” is an indicator of the degree of turbidness of the liquid mixture containing a siloxane compound (produced by Shin-Etsu Chemical Co., Ltd.) and water at 1:1 equivalent. More specifically, a liquid mixture of water and a siloxane compound in which phase separation was confirmed by visual observation is indicated by “Phase separation” and a liquid mixture in which phase separation was not readily recognizable by naked eye was analyzed according to Testing methods for industrial water (JIS K0101) to determine the numerical value of “Turbidity”.

Siloxane compounds 1 to 5 shown in Table 3 are siloxane compounds having structures represented by formula (1). Comparative siloxane compounds 1 and 2 are siloxane compounds having structures represented by formula (1) but not satisfying the fourth technical requirement that the functional group equivalent is 500 g/mol or more and 4500 g/mol or less. Comparative siloxane compound 3 has a structure represented by formula (1) but does not satisfy the third technical requirement that a 1:1 (w/w) mixture of the siloxane compound and water is in a phase separation state or exhibits a turbidity of 200 FTU or more.

The siloxane compounds 1 to 5 and the comparative siloxane compounds 1 to 3 shown in Table 3 each have one or two functional groups, each of which is an organic group containing oxygen or nitrogen. Calculation of the functional group equivalent for such a functional group is as described above.

TABLE 3

| | | | | | Turbidity of 1:1 |
|---|---|---|---|---|---|
| | | | Functional | | water/siloxane |
| | Siloxane | Organic group containing | group | | compound liquid |
| | compound | oxygen or nitrogen | equivalent | | mixture |
| Siloxane | X-22-161B | Amino group (containing | 1500 | (g/mol) | 200 FTU or more |
| compound 1 | | nitrogen) | | | |
| Siloxane | X-22-3701E | Carboxyl group (containing | 4000 | (g/mol) | Phase separation |
| compound 2 | | oxygen) | | | |
| Siloxane | KF-6003 | Carbinol group (containing | 2545 | (g/mol) | Phase separation |
| compound 3 | | oxygen) | | | |
| Siloxane | X-21-5841 | Silanol (containing oxygen) | 500 | (g/mol) | 200 FTU or more |
| compound 4 | | | | | |
| Siloxane | X-22-4515 | Ethylene oxide group | 600-1500 | (g/mol) | 200 FTU or more |
| compound 5 | | (containing oxygen) and | | | |
| | | propylene oxide group | | | |
| | | (containing oxygen) | | | |
| Comparative | X-22-160AS | Carbinol group (containing | 467 | (g/mol) | Phase separation |
| siloxane | | oxygen) | | | |
| compound 1 | | | | | |
| Comparative | X-22-170DX | Carbinol group (containing | 4667 | (g/mol) | Phase separation |
| siloxane | | oxygen) | | | |
| compound 2 | | | | | |
| Comparative | KF-643 | Ethylene oxide group | 700-1000 | (g/mol) | 200 FTU or more |
| siloxane | | (containing oxygen) and | | | |
| compound 3 | | propylene oxide group | | | |
| | | (containing oxygen) | | | |

TABLE 4

| | | Polymer | | | |
|---|---|---|---|---|---|
| | Pigment | particle | | | |
| | dispersion liquid | dispersion | Solvent | Water | Surfactant |
| Ink 1 | Black pigment | 50 mass % | Diethylene | 14 | BYK 349 |
| | dispersion liquid | | glycol | mass % | 6 mass % |
| | 20 mass % | | 10 mass % | | |
| Ink 2 | Black pigment | 50 mass % | Diethylene | 19 | Acetylenol |
| | dispersion liquid | | glycol | mass % | EH |
| | 20 mass % | | 10 mass % | | 1 mass % |

The intermediate transfer bodies, the liquid compositions, and the types of the inks used in the examples are indicated in Table 5 below.

TABLE 5

| | Intermediate transfer body | Liquid composition | Ink |
|---|---|---|---|
| Example 1 | Intermediate transfer | Liquid composition 1 | Ink 1 |
| | body A | | |
| Example 2 | Intermediate transfer | Liquid composition 2 | Ink 1 |
| | body A | | |
| Example 3 | Intermediate transfer | Liquid composition 3 | Ink 1 |
| | body A | | |
| Example 4 | Intermediate transfer | Liquid composition 4 | Ink 1 |
| | body A | | |
| Example 5 | Intermediate transfer | Liquid composition 5 | Ink 1 |
| | body A | | |
| Example 6 | Intermediate transfer | Liquid composition 1 | Ink 1 |
| | body B | | |
| Example 7 | Intermediate transfer | Liquid composition 1 | Ink 2 |
| | body A | | |
| Comparative | Intermediate transfer | Comparative liquid | Ink 1 |
| Example 1 | body A | composition 1 | |
| Comparative | Intermediate transfer | Comparative liquid | Ink 1 |
| Example 2 | body A | composition 2 | |
| Comparative | Intermediate transfer | Comparative liquid | Ink 1 |
| Example 3 | body A | composition 3 | |
| Comparative | Intermediate transfer | Comparative liquid | Ink 1 |
| Example 4 | body A | composition 4 | |
| Comparative | Comparative intermediate | Liquid composition 1 | Ink 1 |
| Example 5 | transfer body C | | |

### Evaluation

In the step (a) of applying a liquid composition in the recording method described above, a liquid composition was applied to a 50 mm×50 mm region in the surface of the intermediate transfer body. The property of the liquid composition applied was evaluated by the following standard.

### Application Property: Whether the Liquid Composition can Evenly Applied to the Intermediate Transfer Body

The appearance of the liquid composition formed on the surface of the intermediate transfer body after the step (a) of applying the liquid composition was observed with an optical microscope and evaluated by the following standard:

A: Of the area to which the liquid composition was applied, the area of the intermediate transfer body surface that repelled the liquid composition and thus remained exposed accounts for 0% or more and less than 5%.
B: Of the area to which the liquid composition was applied, the area of the intermediate transfer body surface that repelled the liquid composition and thus remained exposed accounts for 5% or more and less than 15%.
C: Of the area to which the liquid composition was applied, the area of the intermediate transfer body surface that repelled the liquid composition and thus remained exposed accounts for 15% or more.

In the step (b) of forming an intermediate image, a 20 mm×20 mm intermediate image (100% duty solid image) was formed on the 50 mm×50 mm region in the intermediate transfer body surface to which the liquid composition had been applied in the step (a). The image quality of the intermediate image and the transfer property to the recording medium were evaluated according to the following standards:

Quality of intermediate image: in-plane density unevenness of solid image

The in-plane density unevenness of the intermediate image (solid image) after the step of forming an intermediate image was measured with a flat spectrometer (PSA-700E produced by JFE Techno-Research Corporation) by extracting about 40,000 points per 0.1 mm square so that the optical density (O.D.) at these points were measured. The optical density was evaluated by the following standard.

A: The number of points at which the measured O.D. was in the range of “average value of all measured values −0.2” to “average value of all measured values +0.2” was 90% or more and 100% or less of the number of all the points at which the measurement was conducted.
B: The number of points at which the measured O.D. was in the range of “average value of all measured values −0.2” to “average value of all measured values +0.2” was 70% or more and less than 90% of the number of all the points at which the measurement was conducted.
C: The number of points at which the measured O.D. was in the range of “average value of all measured values −0.2” to “average value of all measured values +0.2” was less than 70% of the number of all the points at which the measurement was conducted.
Transfer Property: Percentage of the Area of the Surface of the Intermediate Transfer Body in which the Ink Remained

The surface of the intermediate transfer body after the transfer step (d) was observed with an optical microscope and the percentage of the area of the surface of the intermediate transfer body in which the ink remained (ink remaining area percentage) was evaluated according to the following standard. The ink remaining area percentage is assumed to be 0% when all of the ink was transferred onto the recording medium and no parts of the intermediate image remained on the intermediate transfer body.

A: The ink remaining area percentage was 0% or more and less than 5%.
B: The ink remaining area percentage was 5% or more and less than 15%.
C: The ink remaining area percentage was 15% or more.
The evaluation results are shown in Table 6.

TABLE 6

| | Application | Quality of | Transfer |
|---|---|---|---|
| | property | intermediate image | property |
| Example 1 | A | A | A |
| Example 2 | B | B | A |
| Example 3 | B | B | A |
| Example 4 | B | B | A |
| Example 5 | B | B | A |
| Example 6 | A | A | B |
| Example 7 | A | B | A |
| Comparative Example 1 | C | C | A |
| Comparative Example 2 | C | C | A |
| Comparative Example 3 | C | C | A |
| Comparative Example 4 | C | C | B |
| Comparative Example 5 | A | A | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-038857, filed Feb. 24, 2012 which is hereby incorporated by reference herein in its entirety.

What is claimed is:

1. An image recording method comprising:
applying a liquid composition to an intermediate transfer body, the liquid composition containing a reactant capable of agglomerating or precipitating a colorant in an ink;
forming an intermediate image by applying the ink to the intermediate transfer body to which the liquid composition has been applied; and
transferring the intermediate image onto a recording medium,
wherein the intermediate transfer body has a surface that has a contact angle of 50° or more and 120° or less with respect to water,
the liquid composition contains a siloxane compound represented by formula (1) and the siloxane compound is such a siloxane compound that a 1:1 (w/w) mixture of the siloxane compound and water is in a phase separation state or exhibits a turbidity of 200 formazin turbidity units or more, and
the siloxane compound has a functional group equivalent of 500 g/mol or more and 4500 g/mol or less: 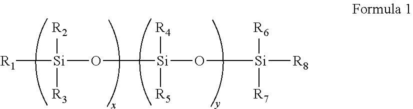
where R₂ and R₃ each represent a monovalent alkyl group; R₁ and R₄ to R₈ each represent a monovalent alkyl group or a functional group which is a monovalent organic group containing oxygen or nitrogen; at least one of R₁ and R₄ to R₈ represents the functional group which is a monovalent organic group containing oxygen or nitrogen; x represents an integer of 0 or more; and y represents an integer of 1 or more.

2. The image recording method according to claim 1, wherein the ink contains a polyether siloxane compound represented by formula (2): 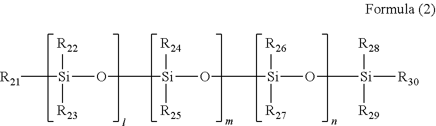
where R₂₁ to R₃₀ each represent a monovalent organic group, at least one of R₂₁ to R₃₀ represents a monovalent organic group that contains a structure represented by formula (3), and l, m, and n each represent an integer of 0 or more:
C₂H₄OₐC₃H₆O_{b} Formula (3)
where a and b each represent an integer of 0 or more and the sum of a and b is an integer of 1 or more.
